(19) United States
(12) Patent Application Publication
(10) Pub. No.: US 2022/0113591 A1
(43) Pub. Date: Apr. 14, 2022

(54) Diffusion plate and backlight module

(71) Applicant: Coretronic Corporation, Hsin-Chu (TW)

(72) Inventors: LIANG-KUO TSAO, Hsin-Chu (TW); YEN-HAO LIN, Hsin-Chu (TW); WEN-PIN YANG, Hsin-Chu (TW)

(21) Appl. No.: 17/464,712

(22) Filed: Sep. 2, 2021

(30) Foreign Application Priority Data
Oct. 12, 2020 (CN) 202022253792.7
Jan. 21, 2021 (TW) 110200750

(51) Int. Cl. G02F 1/13357; G02F 1/1335

(52) U.S. Cl. CPC G02F 1/133606; G02F 1/133611; G02F 1/133614

(57) ABSTRACT

A diffusion plate has a first surface and a second surface opposite to each other, and includes a plurality of first prism pillars and a plurality of second prism pillars. The first prism pillars are disposed on the first surface. An angle range of a first apex angle of the first prism pillar is 60° to 90°. The second prism pillars are disposed on the second surface. An angle range of a second apex angle of the second prism pillar is 60° to 90°. The first prism pillars are arranged along a first direction. The second prism pillars are arranged along a second direction. The first direction is substantially perpendicular to the second direction. A backlight module using the diffusion plate is also provided. The diffusion plate and the backlight module can improve the brightness uniformity.

### CROSS-REFERENCE TO RELATED APPLICATION

This application claims the priority benefit of China application serial no. 202022253792.7, filed on Oct. 12, 2020, and Taiwan application serial no. 110200750, filed on Jan. 21, 2021. The entirety of the above-mentioned patent applications is hereby incorporated by reference herein and made a part of this specification.

### FIELD OF THE INVENTION

The invention relates to a backlight module, and more particularly to a diffusion plate and a backlight module using the diffusion plate.

### BACKGROUND OF THE INVENTION

A general liquid crystal display device includes a liquid crystal display panel and a backlight module. The main function of the backlight module is to provide a light source with high-brightness and high-uniformity.

The backlight modules can be divided into edge-type backlight modules and direct-type backlight modules. In the current direct-type backlight modules, with the thinner modules and the development of Mini LEDs, the gap between Mini LEDs and other optical components (i.e., the optical distance (OD)) is gradually decreased, and can even be zero. However, the decreased gap is more likely to cause inconsistencies in the brightness on the display image, resulting in the problem of dark and bright areas, which is commonly known as the Mura phenomenon.

The existing solution is to add dot-like structures on the diffusion plate, such as the conventional cone-shaped concave structure or dot structure, but these conventional structures have limited improvement effect. In addition, when the dot structure is used, the brightness decrease and alignment shift may happen.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a diffusion plate, which can improve the brightness uniformity.

The invention provides a backlight module, which can improve the brightness uniformity.

Other advantages and objects of the invention may be further illustrated by the technical features broadly embodied and described as follows.

In order to achieve one or part or all of the above-mentioned purposes or other purposes, the diffusion plate provided by an embodiment of the invention has a first surface and a second surface opposite to each other, and includes a plurality of first prism pillars and a plurality of second prism pillars. The first prism pillars are disposed on the first surface. Each of the first prism pillars has a first apex angle, and an angle range of the first apex angle is 60° to 90°. The second prism pillars are disposed on the second surface. Each of the second prism pillars has a second apex angle, and an angle range of the second apex angle is 60° to 90°. The first prism pillars are arranged along a first direction. The second prism pillars are arranged along a second direction. The first direction is substantially perpendicular to the second direction.

In an embodiment of the invention, the first surface is a rectangle, and an angle between the first direction and a long side of the first surface is 0° to 30°.

In an embodiment of the invention, a cross section of each of the first prism pillars parallel to the first direction and a cross section of each of the second prism pillars parallel to the second direction are the same.

In an embodiment of the invention, a height of the first prism pillars in a direction perpendicular to the first surface is 10 μm to 100 μm. A height of the second prism pillars in a direction perpendicular to the second surface is 10 μm to 100 μm. A distance between any two adjacent first apex angles is 11.5 μm to 200 μm. A distance between any two adjacent second apex angles is 11.5 μm to 200 μm.

In an embodiment of the invention, a haze of the diffusion plate is less than 1%.

In an embodiment of the invention, there is no space between any two adjacent first prism pillars, and there is no space between any two adjacent second prism pillars.

In order to achieve one or part or all of the above-mentioned purposes or other purposes, the backlight module provided by an embodiment of the invention includes a substrate, a plurality of light-emitting elements and the aforementioned diffusion plate. The substrate has a carrying surface. The light-emitting elements are disposed on the carrying surface and arranged in an array. The diffusion plate is disposed beside the substrate and faces the light-emitting elements.

In an embodiment of the invention, a shortest distance between any two adjacent light-emitting elements is less than 5 mm, and a distance between the light-emitting elements and the diffusion plate is less than 0.5 mm.

In an embodiment of the invention, a pillar direction of the array is parallel to the first direction, and a row direction of the array is parallel to the second direction.

In an embodiment of the invention, the aforementioned backlight module further includes a reflection sheet disposed on the carrying surface and having a plurality of openings. The light-emitting elements are respectively disposed to penetrate through the openings.

In an embodiment of the invention, the aforementioned backlight module further includes a wavelength conversion module and a brightness enhancement module. The wavelength conversion module is disposed to overlap with the diffusion plate. The wavelength conversion module and the diffusion plate are disposed between the substrate and the brightness enhancement module.

In an embodiment of the invention, the aforementioned backlight module further includes an optical film disposed to overlap with the diffusion plate.

In an embodiment of the invention, the aforementioned backlight module further includes an ink coating disposed on a surface of the diffusion plate.

In an embodiment of the invention, the aforementioned backlight module further includes an optical film and an ink coating. The optical film is disposed to overlap with the diffusion plate. The ink coating is disposed on at least one of the diffusion plate and the optical film.

In an embodiment of the invention, the ink coating includes a plurality of ink dots, and a distribution density of the ink dots corresponds to a position of the light-emitting elements.

In the backlight module of the embodiment of the invention, the first surface and the second surface of the diffusion plate are respectively provided with a plurality of first prism pillars and a plurality of second prism pillars. Thus, the light emitted by the light-emitting elements will be split twice when passing through the diffusion plate. In addition, the directions of the two light splitting are different due to the first direction along which the first prism pillars are arranged is substantially perpendicular to the second direction along which the second prism pillars are arranged. In addition, after the first light splitting of the second prism pillars, the incident angle of the light is likely to form total reflection on the first prism pillars. Thus, the effect of light splitting is improved, the uniform light splitting is achieved, and the situation in which the brightness of the area of the diffusion plate directly above the light emitting elements is too high and the brightness of the area of the diffusion plate directly above the zone between the two adjacent light emitting elements is too low is improved, thereby improving the overall brightness uniformity.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional diagram of a backlight module according to an embodiment of the invention;

FIG. 2 is a schematic cross-sectional view of the diffusion plate, taken along the line A-A′ in FIG. 1;

FIG. 3 is a schematic top view of a diffusion plate according to another embodiment of the invention;

FIG. 4A is a schematic cross-sectional view of a backlight module according to an embodiment of the invention;

FIG. 4B is a schematic cross-sectional view of a backlight module according to another embodiment of the invention;

FIG. 5 is a schematic diagram of the comparison result of brightness uniformity between the backlight module of the prior art and the backlight module of the invention;

FIG. 6 is a schematic cross-sectional view of a backlight module according to another embodiment of the invention;

FIG. 7A is a schematic cross-sectional view of a backlight module according to another embodiment of the invention;

FIG. 7B is a schematic cross-sectional view of a backlight module according to another embodiment of the invention;

FIG. 8 is a schematic cross-sectional view of a backlight module according to another embodiment of the invention;

FIG. 9A is a schematic diagram of a plurality of ink dots disposed on a diffusion plate according to an embodiment of the invention;

FIG. 9B is a schematic diagram of a plurality of ink dots disposed on a diffusion plate according to another embodiment of the invention;

FIG. 10 is a schematic cross-sectional view of a backlight module according to another embodiment of the invention; and

FIG. 11 is a schematic cross-sectional view of a backlight module according to another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

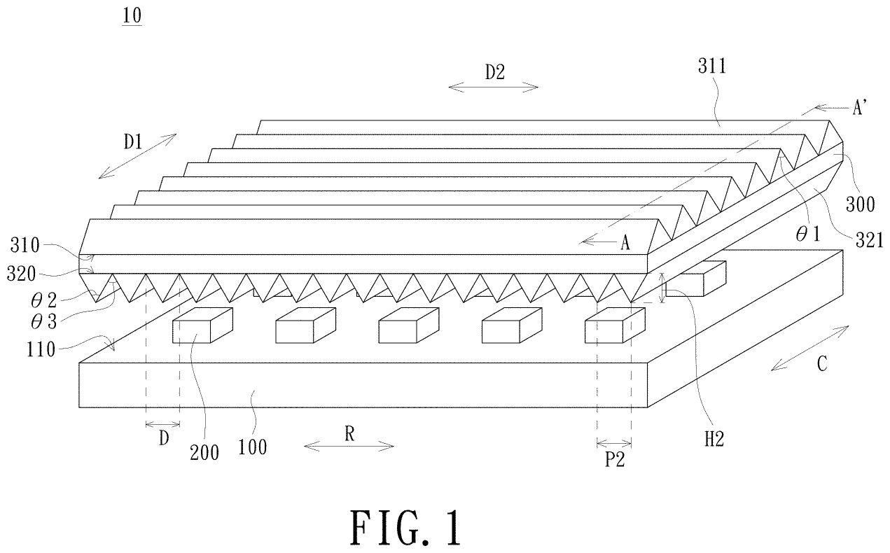

FIG. 1 is a schematic three-dimensional diagram of a backlight module according to an embodiment of the invention. Please refer to FIG. 1. The backlight module 10 of this embodiment includes a substrate 100, a plurality of light-emitting elements 200 and a diffusion plate 300. The substrate 100 has a carrying surface 110. The light-emitting elements 200 are disposed on the carrying surface 110 and arranged in an array. Specifically, the backlight module 10 is a direct-type backlight module. The diffusion plate 300 is disposed beside the carrying surface 110 of the substrate 100 and faces the light-emitting elements 200. The diffusion plate 300 has a first surface 310 and a second surface 320 opposite to each other, and includes a plurality of first prism pillars 311 and a plurality of second prism pillars 321. In this embodiment, the second surface 320 of the diffusion plate 300 faces the light-emitting elements 200, but is not limited thereto. In another embodiment, the first surface 310 of the diffusion plate 300 may face the light-emitting elements 200. The first prism pillars 311 are disposed on the first surface 310 and arranged along a first direction D1, and the first prism pillars 311 can selectively extend along a second direction D2. The second prism pillars 321 are disposed on the second surface 320 and arranged along the second direction D2, and the second prism pillars 321 can selectively extend along the first direction D1. The first direction D1 and the second direction D2 are substantially perpendicular. The shapes of the substrate 100 and the diffusion plate 300 of the invention are, for example, rectangular, but not limited thereto. In another embodiment, the shapes of the substrate 100 and the diffusion plate 300 may be polygonal. In this embodiment, the first direction D1 may be parallel to the short side of the first surface 310, and the second direction D2 may be parallel to the long side of the first surface 310, but the invention is not limited thereto. With regard to the arrangement of the prism pillars, the first prism pillars 311 and the second prism pillars 321 can be respectively formed on the first surface 310 and the second surface 320 of the diffusion plate 300 through an embossing process (embossing the surfaces of the diffusion plate), for example. Alternatively, the first prism pillars 311 and the second prism pillars 321 can be respectively formed by coating the first surface 310 and the second surface 320 of the diffusion plate 300 with optical glue (e.g., UV glue), performing an embossing process (embossing the optical glue) to produce the prism pillars, and then curing and molding the prism pillars.

The light emitting element 200 is, for example, mini light emitting diode (mini LED), but is not limited thereto. The array formed by the light-emitting elements 200 has a row direction R and a column direction C. For the convenience of description, taking FIG. 1 as an example, the horizontal direction is the row direction R, the vertical direction is the column direction C, the number of light-emitting elements 200 in the row direction R is five, and the number of light-emitting elements 200 in the column direction C is two, but the invention does not particularly limit the number of light-emitting elements 200. In this embodiment, the column direction C of the array is, for example, parallel to the first direction D1, and the row direction R of the array is, for example, parallel to the second direction D2, but are not limited thereto. In another embodiment, the column direction C of the array may be parallel to the second direction D2, and the row direction R of the array is parallel to the first direction D1.

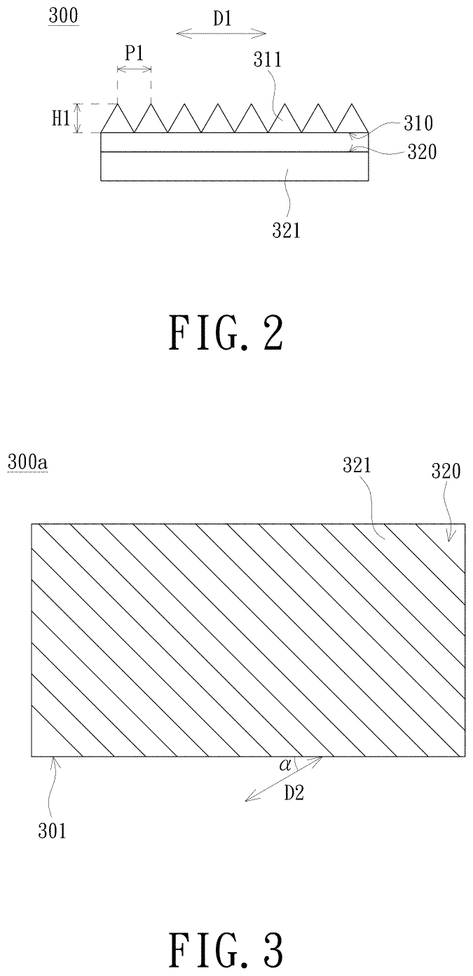

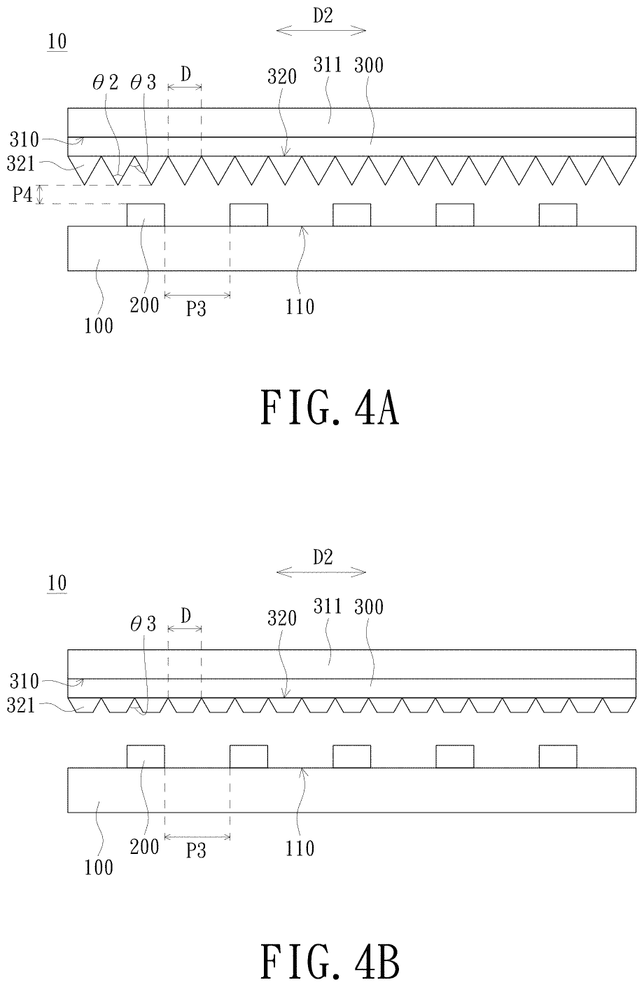

FIG. 3 is a schematic top view of a diffusion plate according to another embodiment of the invention. Please refer to FIGS. 1 and 3 together. In the embodiment of FIG. 3, the first surface 310 and the second surface 320 of the diffusion plate 300a are rectangular. The angle α between the second direction D2 and a long side 301 of the second surface 320 is 0° to 30°, and therefore the angle between the first direction D1 and the long side 301 should be 60° to 90° (not shown) due to that the first direction D1 and the second direction D2 are substantially perpendicular to each other. Alternatively, the angle α between the second direction D2 and the long side 301 of the second surface 320 can be 60° to 90°, and therefore the angle between the first direction D1 and the long side 301 can be 0° to 30°, but the invention is not particularly limited thereto. In addition, the row direction R of the array of this embodiment is not parallel to the first direction D1 nor the second direction D2, and the column direction C is not parallel to the first direction D1 nor the second direction D2, for example. The first prism pillars 311 and the second prism pillars 321 of the diffusion plate 300 of this embodiment will be described in detail with reference to FIGS. 1 and 2.

FIG. 2 is a schematic cross-sectional view of the diffusion plate, taken along the line A-A′ in FIG. 1. Please refer to FIGS. 1 and 2 together. The first prism pillars 311 and the second prism pillars 321 of the diffusion plate 300 of this embodiment are, for example, the prism pillars used in the technical field of the invention, which has a shape of triangular pillar, but are not limited thereto. In this embodiment, the first prism pillar 311 and the second prism pillar 321 use, for example, the prism pillars of the same shape, but are not limited thereto. Specifically, the dimensions of the first prism pillars 311 and the second prism pillars 321 are the same, and the cross section of each first prism pillar 311 parallel to the first direction D1 and the cross section of each second prism pillar 321 parallel to the second direction D2 are the same (as shown by the edge of the diffusion plate 300 in FIG. 1).

The structural features of the first prism pillar 311 and the second prism pillar 321 of this invention are described as follow. Specifically, each first prism pillar 311 has a first apex angle θ1, wherein the angle range of the first apex angle θ1 is 60° to 90°, and preferably is 70°. Each second prism pillar 321 has a second apex angle θ2 (i.e., the angle between the two sides of the second prism pillar 321), wherein the angle range of the second apex angle θ2 is 60° to 90°. Any two adjacent second prism pillars 321 have a first angle θ3. The first angle θ3 is equal to the second apex angle θ2, and therefore the angle range of the first angle θ3 is 60° to 90°. A height H1 of each first prism pillar 311 in the direction perpendicular to the first surface 310 is 10 μm to 100 μm (shown in FIG. 2). A height H2 of each second prism pillar 321 in the direction perpendicular to the second surface 320 is 10 μm to 100 μm. A width D of each second prism pillar 321 parallel to the second direction D2 is 11.5 μm to 200 μm. A distance P1 between any two adjacent first apex angles θ1 is 11.5 μm to 200 μm (shown in FIG. 2). A distance P2 between any two adjacent second apex angles θ2 is 11.5 μm to 200 μm.

In addition, there is, for example, no space between any two adjacent first prism pillars 311. That is, there is no flat surface between any two adjacent first prism pillars 311 parallel to the first surface 310, or, the first surface 310 is not exposed between any two adjacent first prism pillars 311, but is not limited thereto. In another embodiment, there may be a space between any two adjacent first prism pillars 311. That is, the first surface 310 is exposed between any two adjacent first prism pillars 311, and the space between any two adjacent first prism pillars 311 (i.e., the width of the exposed first surface 310) is smaller than the width of the first prism pillar 311 in the first direction D1. Similarly, there is, for example, no space between any two adjacent second prism pillars 321, but is not limited thereto. In another embodiment, there may be a space between any two adjacent second prism pillars 321, and the space is smaller than the width of the second prism pillar 321 in the second direction D2.

In the backlight module 10 of this embodiment, the first surface 310 and the second surface 320 of the diffusion plate 300 are respectively provided with a plurality of first prism pillars 311 and a plurality of second prism pillars 321. Thus, the light emitted by the light-emitting elements 200 will be split twice when passing through the diffusion plate 300. In addition, the directions of the two light splitting are different due to the first direction D1 along which the first prism pillars 311 are arranged is substantially perpendicular to the second direction D2 along which the second prism pillars 321 are arranged. In addition, after the first light splitting of the second prism pillars 321, the incident angle of the light is likely to form total reflection on the first prism pillars 311. Thus, the effect of light splitting is improved, the uniform light splitting is achieved, and the situation in which the brightness of the area of the diffusion plate 300 directly above the light emitting elements 200 is too high and the brightness of the area of the diffusion plate 300 directly above the zone between the two adjacent light emitting elements 200 is too low is improved, thereby improving the overall brightness uniformity.

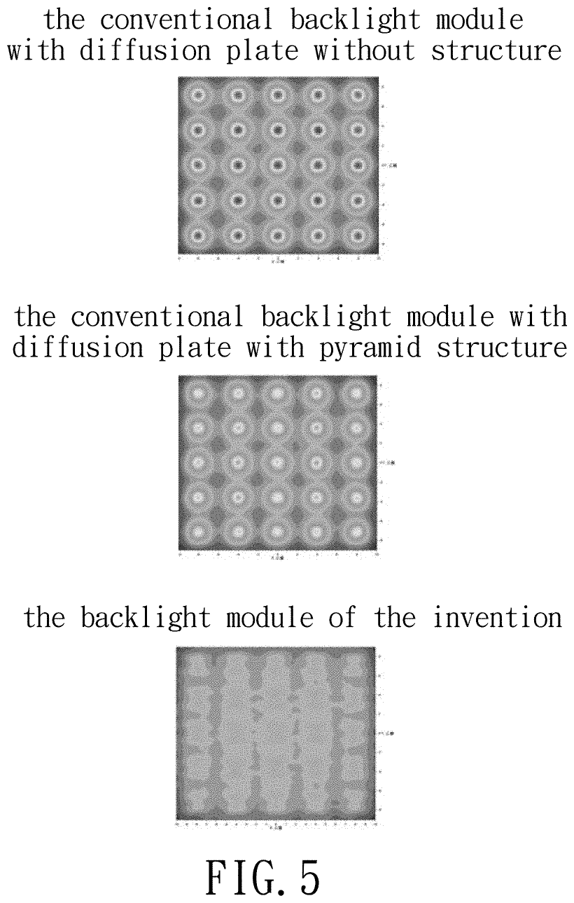

The backlight module 10 of this embodiment may also have the following designs to achieve the above-mentioned effects. FIG. 4A is a schematic cross-sectional view of a backlight module according to an embodiment of the invention. FIG. 4B is a schematic cross-sectional view of a backlight module according to another embodiment of the invention. Please refer to FIG. 4A first. In this embodiment, a shortest distance P3 between any two adjacent light-emitting elements 200 is, for example, less than 5 mm, and preferably is 4 mm. It should be noted that the shortest distance P3 referred to this embodiment is defined as the distance between any two adjacent light-emitting elements 200 in the column direction C or the row direction R of the array (please refer to FIG. 1). In addition, the distance P4 between the light-emitting elements 200 and the diffusion plate 300 is, for example, less than 0.5 mm Thus, the backlight module 10 of this embodiment can improve the overall brightness uniformity while reducing the distance P4 between the light-emitting elements 200 and the diffusion plate 300, and therefore the module can be made lighter and thinner, but the Mura phenomenon can be reduced. Furthermore, in this embodiment, the cross section of each second prism pillar 321 parallel to the second direction D2 is triangular and has a sharp tip (i.e., the second vertex angle θ2), but the invention is not limited thereto. In other embodiments, the tip of each second prism pillar 321 may be a flat surface (please refer to FIG. 4B) or in other shapes, and the width of the flat surface of the tip of each second prism pillar 321 may be, for example, 1 μm to 5 μm. In the embodiment in which the tip of the second prism pillar 321 is a flat surface or in other shapes, the angle of the second apex angle θ2 can be defined by the angle between the two sides of the second prism pillar 321 (the angle between the extensions of the two sides).

The haze of the diffusion plate 300 can be, for example, less than 1% due to that the light-splitting effect of the backlight module 10 of this embodiment can be achieved by the first prism pillars 311 and the second prism pillars 321 arranged on the diffusion plate 300. The diffusion plate 300 of this embodiment does not have diffusion particles, for example. That is, the diffusion plate 300 is composed of the same material, and the surface of the prism pillars does not have a microstructure, but the invention is not limited thereto.

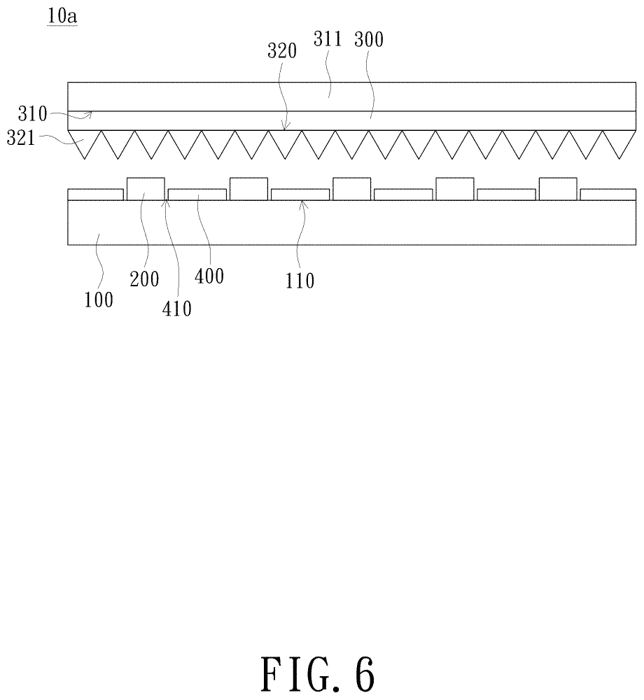

FIG. 5 is a schematic diagram of the comparison result of brightness uniformity between the backlight module of the prior art and the backlight module of the invention. Please refer to FIG. 5. The experiment uses LightTools optical software to simulate the brightness uniformity of the backlight module of the prior art and the backlight module 10 of the invention, wherein the more obvious the contrast between light and dark in the figure, the lower the brightness uniformity. As shown in FIG. 5, the conventional backlight module with diffusion plate without structure in the top figure has the most obvious contrast between light and dark, followed by the conventional backlight module with diffusion plate with pyramid structure in the middle figure, and finally the backlight module 10 of the invention in the bottom figure has the least obvious contrast between light and dark. Therefore, the backlight module 10 of the invention has higher brightness uniformity than the conventional backlight module.

According to the experimental results, the brightness uniformity of the backlight module 10 of this embodiment is higher than the conventional backlight module. Specifically, compared with the conventional backlight module with diffusion plate with pyramid structure, the backlight module 10 including the diffusion plate 300 provided with the first prism pillars 311 and the second prism pillars 321 has a brightness uniformity improved by at least 45%.

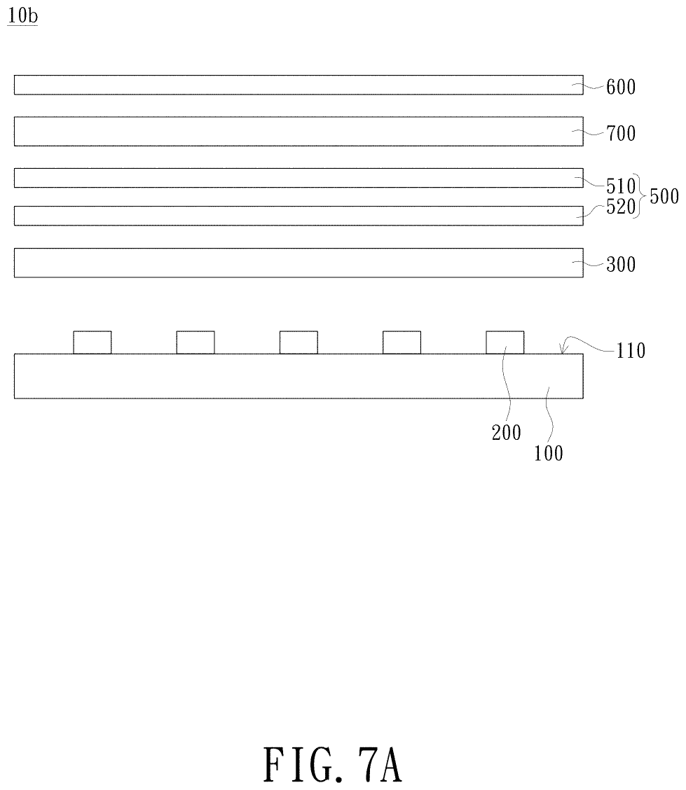

FIG. 6 is a schematic cross-sectional view of a backlight module according to another embodiment of the invention. Please refer to FIG. 6. The structure and advantages of the backlight module 10a of this embodiment are similar to those of the backlight module 10 of FIG. 1. The only difference is that the backlight module 10a of this embodiment further includes a reflection sheet 400 disposed on the carrying surface 110. The reflection sheet 400 has, for example, a plurality of openings 410. The light-emitting elements 200 are respectively disposed to penetrate through the openings 410. The reflection sheet 400 is configured to reflect the light emitted by the light emitting elements 200 and reflect the light reflected from the diffusion plate 300 back to the diffusion plate 300, so that the brightness of the backlight module 10a can be further improved.

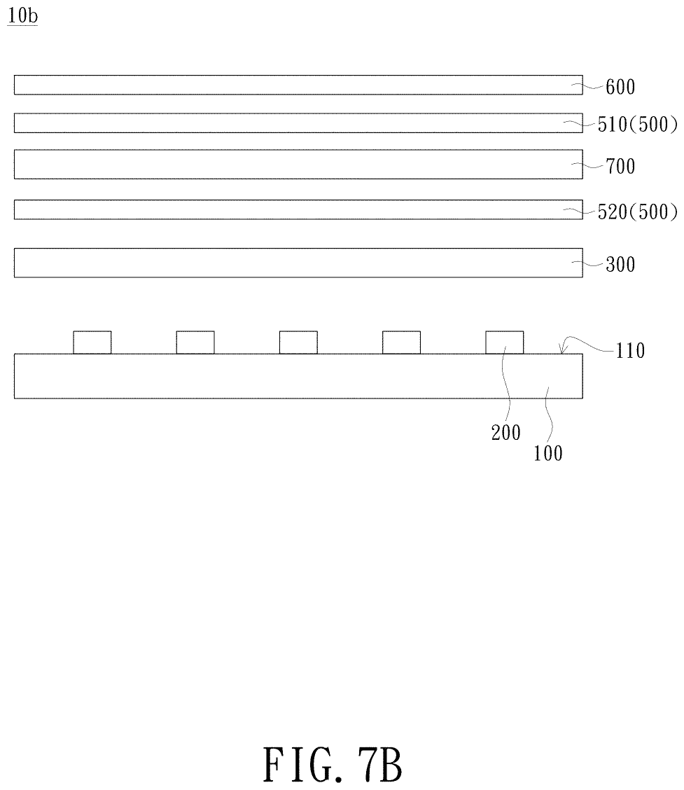

FIG. 7A is a schematic cross-sectional view of a backlight module according to another embodiment of the invention. FIG. 7B is a schematic cross-sectional view of a backlight module according to another embodiment of the invention. Please refer to FIG. 7A first. The structure and advantages of the backlight module 10b of this embodiment are similar to those of the backlight module 10 of FIG. 1, and only the main differences in structure will be described below. The backlight module 10b of this embodiment further includes a wavelength conversion module 500 and a brightness enhancement module 600. The wavelength conversion module 500 is disposed to overlap with the diffusion plate 300, and the wavelength conversion module 500 and the diffusion plate 300 are disposed between the substrate 100 and the brightness enhancement module 600. In this embodiment, the diffusion plate 300 is disposed between the substrate 100 and the wavelength conversion module 500, but is not limited thereto. In another embodiment, the diffusion plate 300 is disposed between the brightness enhancement module 600 and the wavelength conversion module 500. Specifically, the wavelength conversion module 500 includes a wavelength conversion film 510 and a filter 520, but is not limited thereto. The filter 520 is disposed between the wavelength conversion film 510 and the substrate 100, and is configured to allow blue light to pass therethrough and reflect light of other colors. The light emitting element 200 of this embodiment provides blue light, for example. The wavelength conversion film 510 is configured to convert blue light into light with other wavelengths, wherein different wavelength conversion materials can also be selected according to different design requirements. In other embodiments, the diffusion plate 300 may be disposed between the wavelength conversion film 510 and the filter 520. Specifically, the diffusion plate 300 may be disposed between any two adjacent films when the wavelength conversion module 500 includes a plurality of films.

The brightness enhancement module 600 includes two prisms and a brightness enhancement film (not shown), but is not limited thereto. The arrangement directions of the prism pillars of the two prisms are, for example, perpendicular to each other. In the backlight module 10b, the brightness enhancement module 600 is disposed on the side of the substrate 100 facing the light-emitting elements 200. Specifically, compared with the wavelength conversion module 500 and the diffusion plate 300, the brightness enhancement module 600 is located on the outermost side.

It should be noted that the main purpose of FIG. 7A is to show the layered arrangement of different films in the backlight module 10b, therefore the first prism pillars and the second prism pillars on the diffusion plate 300 are omitted. That is, it does not mean that the diffusion plate 300 in FIG. 7A does not have the prism pillars. Unless otherwise specified, the omitting of the first prism pillars and the second prism pillars also applies to the following embodiments.

The backlight module 10b of this embodiment further includes, for example, an optical film 700 disposed to overlap with the diffusion plate 300. The optical film 700 is a diffusion plate with haze (e.g., the haze is greater than 50%) or a transparent plastic sheet, but is not limited thereto. The optical film 700 of this embodiment is disposed between the wavelength conversion module 500 and the brightness enhancement module 600. However, the invention does not particularly limit the layered arrangement of the diffusion plate 300, the wavelength conversion module 500 and the optical film 700 between the substrate 100 and the brightness enhancement module 600. For example, the diffusion plate 300 is disposed between the wavelength conversion module 500 and the brightness enhancement module 600, and the optical film 700 is disposed between the wavelength conversion module 500 and the substrate 100; or the diffusion plate 300 is disposed between the substrate 100 and the wavelength conversion module 500, and the optical film 700 is disposed between the diffusion plate 300 and the wavelength conversion module 500; or the diffusion plate 300 is disposed between the substrate 100 and the wavelength conversion module 500, and the optical film 700 is disposed between the diffusion plate 300 and the substrate 100.

Please refer to FIG. 7B. When the wavelength conversion module 500 includes a wavelength conversion film 510 and a filter 520 and the filter 520 is disposed between the wavelength conversion film 510 and the substrate 100, the layered arrangement of the diffusion plate 300, the wavelength conversion film 510, the filter 520 and the optical film 700 between the substrate 100 and the brightness enhancement module 600 is, for example, the diffusion plate 300 is disposed between the substrate 100 and the filter 520 and the optical film 700 is disposed between the wavelength conversion film 510 and the filter 520, but is not limited thereto. For example, the diffusion plate 300 is disposed between the wavelength conversion film 510 and the filter 520, and the optical film 700 is disposed between the substrate 100 and the filter 520; or the diffusion plate 300 is disposed between the wavelength conversion film 510 and the filter 520, and the optical film 700 is disposed between the wavelength conversion film 510 and the brightness enhancement module 600; or the diffusion plate 300 is disposed between the wavelength conversion film 510 and the brightness enhancement module 600, and the optical film 700 is disposed between the wavelength conversion film 510 and the filter 520; or the diffusion plate 300 is disposed between the wavelength conversion film 510 and the filter 520, and the optical film 700 is disposed between the diffusion plate 300 and the wavelength conversion film 510; or the diffusion plate 300 is disposed between the wavelength conversion film 510 and the filter 520, and the optical film 700 is disposed between the diffusion plate 300 and the filter 520. There may be more layered arrangements, depending on the number of films included in the wavelength conversion module 500.

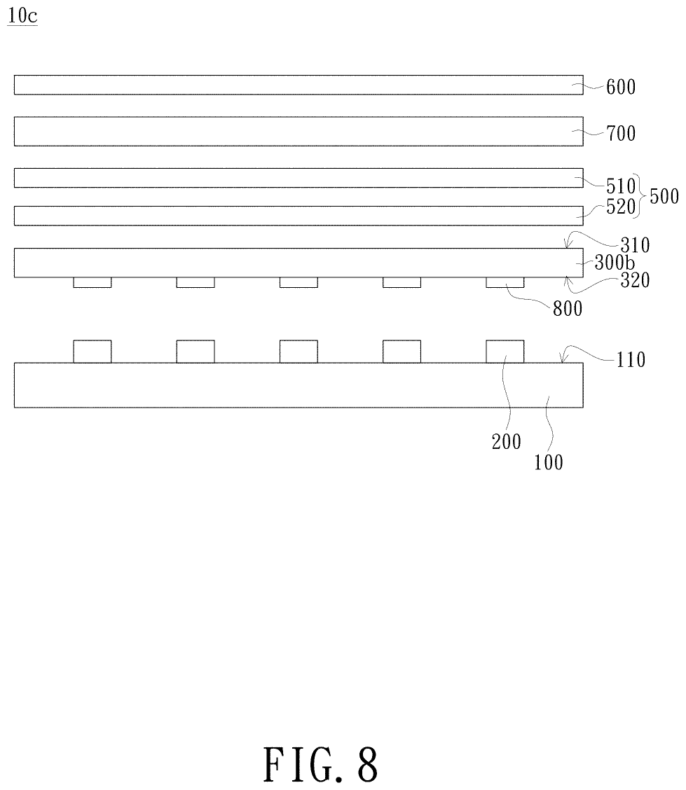

FIG. 8 is a schematic cross-sectional view of a backlight module according to another embodiment of the invention. Please refer to FIG. 8. The structure and advantages of the backlight module 10c of this embodiment are similar to those of the backlight module 10b of FIG. 7A. The only difference is that the backlight module 10c of this embodiment further includes, for example, an ink coating 800 disposed on the surface of the diffusion plate 300b. In this embodiment, the ink coating 800 is disposed on the second surface 320 of the diffusion plate 300b (e.g., the surface close to the substrate 100) as an example, but is not limited thereto. In other embodiments, the ink coating 800 may be disposed on the first surface 310 of the diffusion plate 300b, or may be disposed on both of the first surface 310 and the second surface 320 of the diffusion plate 300b. The disposing of the ink coating 800 is not affected by the prism pillars due to the height of the first prism pillars and the second prism pillars (not shown) is only 10 μm to 100 μm. The ink coating 800 is white ink, but not limited thereto. The ink coating 800 is configured to absorb or reflect part of the light emitted by the light-emitting elements 200 (the other part of the light may be diffused and pass through the ink coating 800, for example), so as to improve the situation in which the brightness of the area of the diffusion plate 300b directly above the light emitting elements 200 is too high. Thus, in FIG. 8, the number of dense areas of the ink coating 800 corresponds to the number of light-emitting elements 200, and the arrangement position of the dense areas of the ink coating 800 corresponds to the arrangement position of the light-emitting elements 200, for example, wherein the number of the light-emitting elements 200 is only an example.

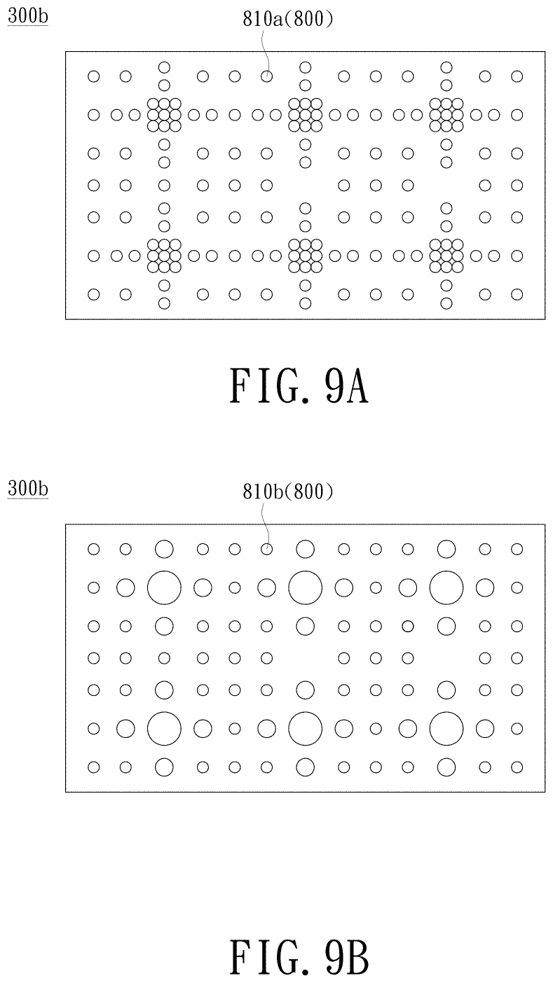

Specifically, the ink coating 800 includes a plurality of ink dots, for example. FIG. 9A is a schematic diagram of a plurality of ink dots disposed on a diffusion plate according to an embodiment of the invention. FIG. 9B is a schematic diagram of a plurality of ink dots disposed on a diffusion plate according to another embodiment of the invention. Please refer to FIGS. 1, 8 and 9A first. The ink coating 800 includes a plurality of ink dots 810a. The distribution density of the ink dots 810a corresponds to, for example, the position of the light-emitting elements 200. Specifically, the closer the area of the diffusion plate 300b directly above the light emitting elements 200, the larger the number of the ink dots 810a (i.e., the dense area of the ink coating 800). The ink dots 810a are arranged in the manner as shown in FIG. 9A due to that the light emitting elements 200 are arranged in an array. Depending on different arrangements of the light emitting elements 200, the arrangement of the ink dots 810a can also be changed.

Please refer to FIGS. 1, 8 and 9B. In another embodiment, the ink coating 800 includes a plurality of ink dots 810b, the ink dots 810b may be arranged as the closer the area of the diffusion plate 300b directly above the light emitting elements 200, the larger the size of the ink dots 810b, as shown in FIG. 9B.

Please refer to FIG. 8 again. In the backlight module 10c of this embodiment, the layered arrangement of the diffusion plate 300b, the wavelength conversion film 510, the filter 520 and the optical film 700 between the substrate 100 and the brightness enhancement module 600 is, for example, the same as that described in the backlight module 10b, and no redundant detail is to be given herein. In addition, depending on different design requirements, the backlight module 10c may not include the optical film 700.

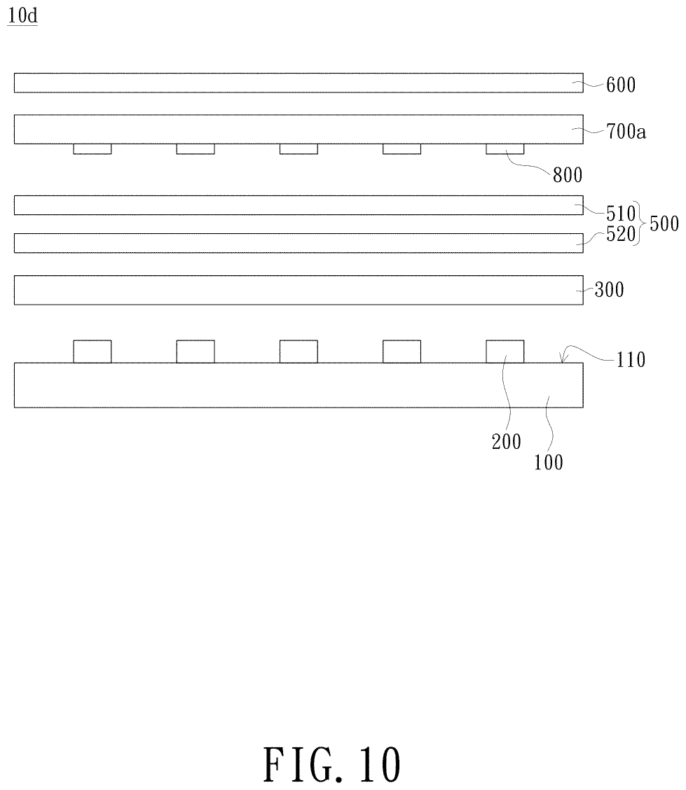

FIG. 10 is a schematic cross-sectional view of a backlight module according to another embodiment of the invention. Please refer to FIG. 10. The structure and advantages of the backlight module 10d of this embodiment are similar to those of the backlight module 10b of FIG. 7A, and only the main differences in structure will be described below. The backlight module 10d of this embodiment further includes, for example, an optical film 700a and an ink coating 800. The ink coating 800 is disposed on the surface of the optical film 700a, such as at least one of the upper surface or the lower surface of the optical film 700a. In FIG. 10, the ink coating 800 is disposed on the lower surface of the optical film 700a as an example. In addition, the arrangement of the ink coating 800 of this embodiment is the same as the arrangement of that on the diffusion plate 300b in the backlight module 10c, and no redundant detail is to be given herein. The layered arrangement of the diffusion plate 300, the wavelength conversion film 510, the filter 520 and the optical film 700a between the substrate 100 and the brightness enhancement module 600 is, for example, the same as that described in the backlight module 10b.

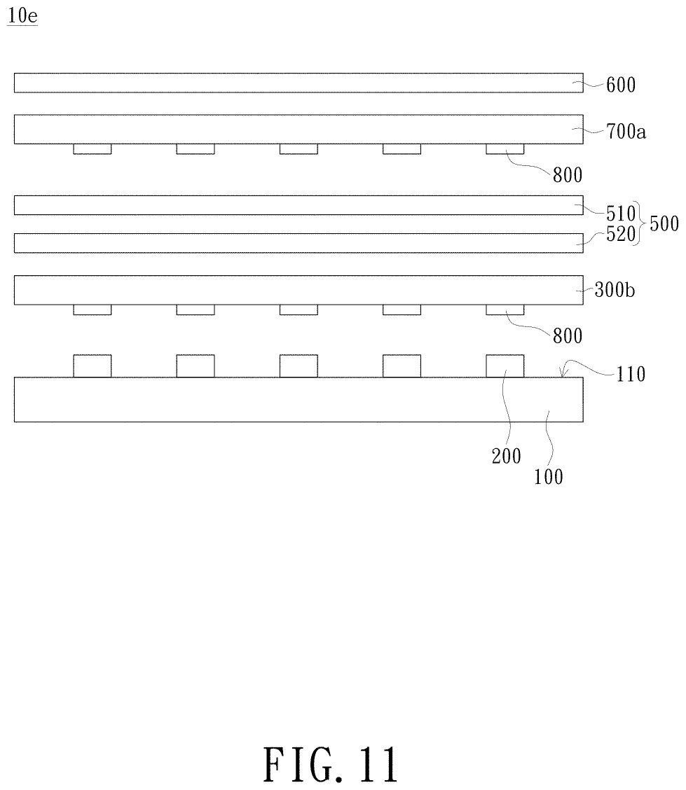

FIG. 11 is a schematic cross-sectional view of a backlight module according to another embodiment of the invention. Please refer to FIG. 11. The structure and advantages of the backlight module 10e of this embodiment are similar to those of the backlight module 10b of FIG. 7A, and only the main differences in structure will be described below. The backlight module 10e of this embodiment further includes, for example, an optical film 700a and an ink coating 800. The ink coating 800 is, for example, disposed on the surface of the optical film 700a, such as at least one of the upper surface or the lower surface of the optical film 700a. In FIG. 11, the ink coating 800 is disposed on the lower surface of the optical film 700a as an example. In addition, the ink coating 800 is also disposed on at least one of the upper surface and the lower surface of the diffusion plate 300b. In this embodiment, the ink coating 800 is disposed on the lower surface of the diffusion plate 300b as an example. According to the backlight modules 10c, 10d and 10e, the ink coating 800 is, for example, disposed on at least one of the diffusion plate 300 (i.e., the diffusion plate 300 provided with the ink coating 800) and the optical film 700 (i.e., the optical film 700a provided with the ink coating 800) when the backlight module includes the optical film 700 and the ink coating 800, but is not limited thereto.

In addition, the arrangement of the ink coating 800 of the backlight module 10e of this embodiment is the same as the arrangement of that on the diffusion plate 300b of the backlight module 10c, and no redundant detail is to be given herein. The layered arrangement of the diffusion plate 300, the wavelength conversion film 510, the filter 520 and the optical film 700a between the substrate 100 and the brightness enhancement module 600 is, for example, the same as that described in the backlight module 10b.

In summary, in the backlight module of the embodiment of the invention, the first surface and the second surface of the diffusion plate are respectively provided with a plurality of first prism pillars and a plurality of second prism pillars. Thus, the light emitted by the light-emitting elements will be split twice when passing through the diffusion plate. In addition, the directions of the two light splitting are different due to the first direction along which the first prism pillars are arranged is substantially perpendicular to the second direction along which the second prism pillars are arranged. In addition, after the first light splitting of the second prism pillars, the incident angle of the light is likely to form total reflection on the first prism pillars. Thus, the effect of light splitting is improved, the uniform light splitting is achieved, and the situation in which the brightness of the area of the diffusion plate directly above the light emitting elements is too high and the brightness of the area of the diffusion plate directly above the zone between the two adjacent light emitting elements is too low is improved, thereby improving the overall brightness uniformity.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first surface, the second surface, the first prism pillar, the second prism pillar, the first direction, the second direction, the first apex angle and the second apex angle are only used for distinguishing various elements and do not limit the number of the elements.

What is claimed is:

1. A diffusion plate, having a first surface and a second surface opposite to each other, and comprising:
a plurality of first prism pillars, disposed on the first surface, wherein each of the first prism pillars has a first apex angle, and an angle range of the first apex angle is 60° to 90°; and
a plurality of second prism pillars, disposed on the second surface, wherein each of the second prism pillars has a second apex angle, and an angle range of the second apex angle is 60° to 90°,
wherein the first prism pillars are arranged along a first direction, the second prism pillars are arranged along a second direction, and the first direction is substantially perpendicular to the second direction.

2. The diffusion plate according to claim 1, wherein the first surface is a rectangle, and an angle between the first direction and a long side of the first surface is 0° to 30°.

3. The diffusion plate according to claim 1, wherein a cross section of each of the first prism pillars parallel to the first direction and a cross section of each of the second prism pillars parallel to the second direction are the same.

4. The diffusion plate according to claim 1, wherein a height of the first prism pillars in a direction perpendicular to the first surface is 10 μm to 100 μm, a height of the second prism pillars in a direction perpendicular to the second surface is 10 μm to 100 μm, a distance between any two adjacent first apex angles is 11.5 μm to 200 μm, and a distance between any two adjacent second apex angles is 11.5 μm to 200 μm.

5. The diffusion plate according to claim 1, wherein a haze of the diffusion plate is less than 1%.

6. The diffusion plate according to claim 1, wherein there is no space between any two adjacent first prism pillars, and there is no space between any two adjacent second prism pillars.

7. A backlight module, comprising:
a substrate, having a carrying surface;
a plurality of light-emitting elements, disposed on the carrying surface and arranged in an array; and
a diffusion plate, disposed beside the substrate and facing the light-emitting elements, the diffusion plate having a first surface and a second surface opposite to each other, and the diffusion plate comprising:
a plurality of first prism pillars, disposed on the first surface, wherein each of the first prism pillars has a first apex angle, and an angle range of the first apex angle is 60° to 90°; and
a plurality of second prism pillars, disposed on the second surface, wherein each of the second prism pillars has a second apex angle, and an angle range of the second apex angle is 60° to 90°,
wherein the first prism pillars are arranged along a first direction, the second prism pillars are arranged along a second direction, and the first direction is substantially perpendicular to the second direction.

8. The backlight module according to claim 7, wherein a shortest distance between any two adjacent light-emitting elements is less than 5 mm, and a distance between the light-emitting elements and the diffusion plate is less than 0.5 mm.

9. The backlight module according to claim 7, wherein a column direction of the array is parallel to the first direction, and a row direction of the array is parallel to the second direction.

10. The backlight module according to claim 7, further comprising a reflection sheet disposed on the carrying surface and having a plurality of openings, wherein the light-emitting elements are respectively disposed to penetrate through the openings.

11. The backlight module according to claim 7, further comprising a wavelength conversion module and a brightness enhancement module, wherein the wavelength conversion module is disposed to overlap with the diffusion plate, and the wavelength conversion module and the diffusion plate are disposed between the substrate and the brightness enhancement module.

12. The backlight module according to claim 7, further comprising an optical film disposed to overlap with the diffusion plate.

13. The backlight module according to claim 11, further comprising an optical film disposed to overlap with the diffusion plate.

14. The backlight module according to claim 7, further comprising an ink coating disposed on a surface of the diffusion plate.

15. The backlight module according to claim 11, further comprising an ink coating disposed on a surface of the diffusion plate.

16. The backlight module according to claim 7, further comprising an optical film and an ink coating, wherein the optical film is disposed to overlap with the diffusion plate, and the ink coating is disposed on at least one of the diffusion plate and the optical film.

17. The backlight module according to claim 11, further comprising an optical film and an ink coating, wherein the optical film is disposed to overlap with the diffusion plate, and the ink coating is disposed on at least one of the diffusion plate and the optical film.

18. The backlight module according to claim 14, wherein the ink coating comprises a plurality of ink dots, and a distribution density of the ink dots corresponds to a position of the light-emitting elements.

19. The backlight module according to claim 15, wherein the ink coating comprises a plurality of ink dots, and a distribution density of the ink dots corresponds to a position of the light-emitting elements.
